(19) United States
(12) Patent Application Publication
(10) Pub. No.: US 2005/0253303 A1
(43) Pub. Date: Nov. 17, 2005

(54) Process for producing a binder for holding navigational aids

(76) Inventor: Francis B. Klimek, Lowell, AR (US)

Correspondence Address: Francis B. Klimek, 504 Emerald Street, Lowell, AR, 72745, US

(21) Appl. No.: 10/844,713

(22) Filed: May 12, 2004

(51) Int. Cl. B29C 31/00

(52) U.S. Cl. 264/339; 264/285

(57) ABSTRACT

The invention relates to a process for producing a binder for holding navigational aids from a single piece of plastic and to the binder so produced.

### FIELD OF THE INVENTION

The invention relates to a process for producing a binder for holding navigational aids from a single piece of plastic and to the binder so produced.

### BACKGROUND OF THE INVENTION

The present invention relates to a process for producing a binder that can be used to hold navigational aids for individual or commercial use. A small marketing survey revealed the Vu-Plate TERP kneeboard (Sportsman's Market, Inc, Batavia Ohio) which is made of plastic and has a VELCRO fastener (Velcro USA, Manchester N.H.) leg strap, the “tri-fold” kneeboard (Jeppesen, Denver Colo.) that has a clear vinyl pocket and the Noral leg strap (Ace's Pilot Shop Kansas City Mo.) which is a length of two inch wide polypropylene webbing that contains a two inch high clear plastic spacer that can be placed over a National Aeronautical Charting Office (NACO) approach plate (FAA, Greenbelt Md.). The vinyl pocket of the “tri-fold” kneeboard is for storing rather than displaying a navigational aid, and the strap allows several inches of the flimsy page of an approach plate to blow in the wind.

The present invention serves a need in the art by presenting a process for producing a binder that: 1) is made from a single piece of plastic, 2) can contain completely and securely and present for viewing an entire page of NACO or Jeppeson (JEPP) approach plate, 3) has a full width and nearly full length clip for holding materials such as maps and flight plans or for attaching the binder to another object such as a kneeboard; 4) needs no additional parts to be fully functional and 5) makes visual and instrument flying safer.

### SUMMARY

The invention provides a process for producing a binder from a single piece of plastic comprising cutting a sheet of plastic into L-shaped pieces, each L-shaped piece having cut edges, a vertical portion and a horizontal portion, wherein the vertical portion measuring about 5 inches wide by about 16 inches high has a top and a base, and the horizontal portion measuring about 5.75 inches to about 7.00 inches wide by about 8.25 inches high is confluent with and extends outward to the left of the base of the vertical portion and has a proximal region near the confluence and a distal region away from the confluence; heating the L-shaped piece of plastic; bending the L-shaped piece of plastic at three bend lines, wherein the vertical portion is bent at a first bend line to fold about 7.75 inches of the top of the vertical region at about a 180 degree angle down towards the base of the vertical region to form a clip with a distal edge and a back cover with a vertical edge and horizontal edge, thereby defining an aperture of about 0.125 inches between the clip and back cover, the horizontal portion is bent at a second bend line at the confluence with the base of the vertical portion to fold about 5.75 inches to about 7.00 inches of the horizontal portion upward at about a 90 degree angle, and the distal region of the horizontal portion is bent at a third bend line about 1 inch to about 1.75 inches distal to the second bend line to fold about 5 inches to 5.25 inches of the distal region of the horizontal portion at about a 110 degree angle to about a 130 degree angle down over the back cover to form a spine between the second bend line and the third bend line with a width of about 0.5 inches to about 1.25 inches and a top cover having a side edge, with a top corner and a bottom corner, aligning with the vertical edge of the back cover and leaving a clearance of at least 0.25 to about 0.375 inches between the side edge of the top cover and the vertical edge of the back cover; and polishing the cut edges of the plastic, thereby producing the binder.

The invention also provides modifications of the binder further comprising heating and folding about 0.5 inch of the distal edge of the clip downward at about a 30 degree to about a 45 degree angle about 0.5 inches of the side edge of the top cover upward at about a 30 degree to about a 45 degree angle or about one diagonal inch of the top corner and/or the bottom corner of the top corner upward at about a 30 degree angle to about a 45 degree angle. The invention also provides modifications of the binder further comprising beveling the side edge of the top cover and vertical edge of the back cover at about a 45 degree angle to a depth of approximately 0.25 inches.

The invention provides a binder produced by the process. The invention also provides a left-handed binder produced by the process wherein the confluent horizontal portion of the L-shaped piece of plastic extends outward to the right of the base of the vertical portion at the beginning of the process.

In one embodiment of the invention, the plastic used to produce the binder is selected from acrylic, polycarbonate, vinyl and hybrid resins. In a preferred embodiment, the plastic is a Lexan resin or a glycol-modified polyethylene terephthalate resin. In one aspect, the plastic is transparent or translucent. In a second aspect of the invention, the plastic is colored. In a third aspect, the plastic has a smooth or matte finish. In a second embodiment, the plastic is an optical grade magnifier or the binder has a sheet magnifier attached to the top cover. In a third embodiment, the binder has a marker and/or a light source attached to it. In a preferred embodiment, the attached light source is a light emitting diode or fiberoptic light.

### FIGURES

FIG. 1. A photograph of a prototype right-handed binder for holding navigational aids.

FIG. 2. A diagram of the top view of an L-shaped piece of plastic as it is would be cut and marked for production of a right-handed binder.

FIG. 3. A diagram of the right side of a right-handed binder.

FIG. 4. A diagram of the base of a right-handed binder.

### DETAILED DESCRIPTION

Definitions

A “binder” refers to any apparatus, clipboard, folder, holder, kneeboard or lapboard that is made from a single piece of plastic—the top cover of which the user can read through, write upon and erase—that can be clipped to a kneeboard, the pocket, hem or cuff of a pair of pants and the like or can be used to hold maps, flight plans and the like.

A marker refers to any instrument for writing on the plastic including a china pencil, an alcohol or water-based color marker, a pen, a grease pencil, a dry erase marker and the like.

A “plastic” refers to a synthetic or semi-synthetic thermoplastic material of acrylic, polycarbonate, vinyl or hybrid origin that can be softened, folded, cooled and hardened so as to become rigid again, and that is light-weight, transparent or translucent, colorless or colored, smooth or matte finish, erasable and that can serve, or be modified to serve, as a magnifier.

Description

The present invention is a process for producing a binder for holding navigational aids. The binder so produced is made from a single piece of plastic; can contain completely and securely and present for viewing an entire flimsy page of NACO or Jeppeson (JEPP) approach plate whether in loose-leaf or bound form; has a full width and nearly full length clip for attaching the binder to another object or for holding maps, flight plans and the like; has no loose parts such as clamps, screws, straps and the like; and makes both visual flying (VFR) and instrument flying (IFR) safer.

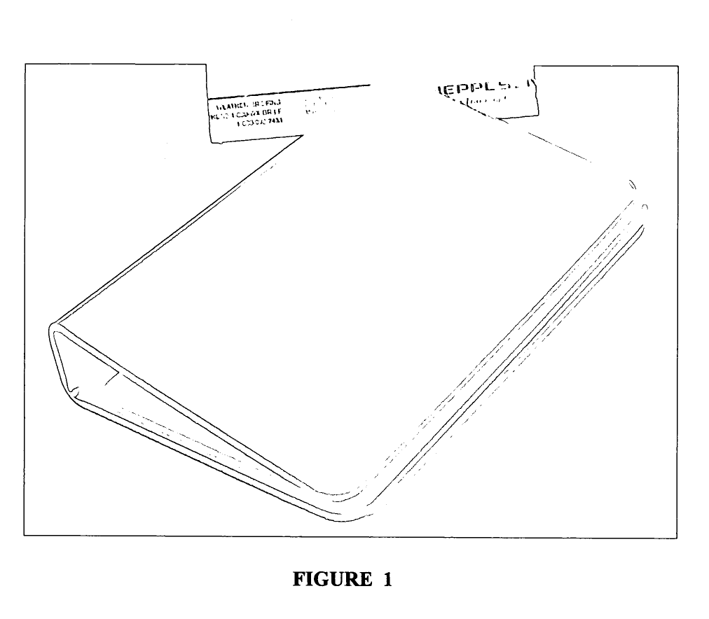

FIG. 1 shows a photograph of a prototype right-handed binder. The binder has a top cover, a spine, and a back cover for holding a navigational aid and a clip to attach the binder to, or to hold, another object.

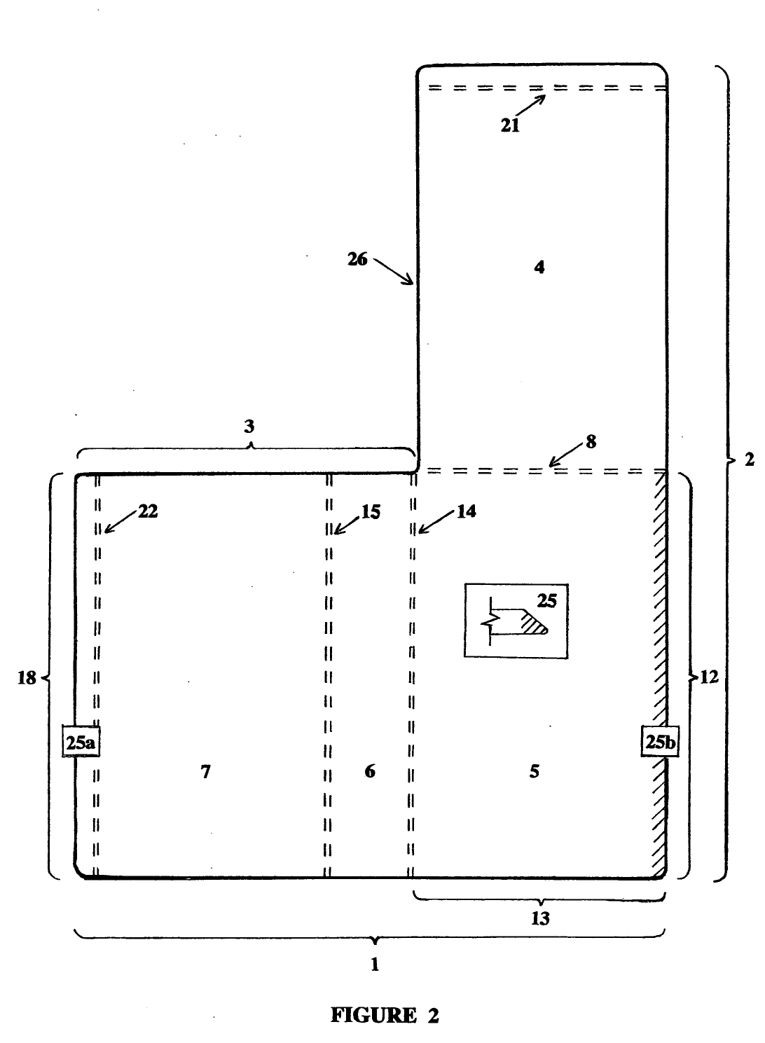

FIG. 2 shows a diagram of the top-view of a single L-shaped piece of plastic (1) with cut edges (26) for making a right-handed binder as it would look when positioned flat on a table, with the horizontal portion of L pointing to the left, in front of a technician who is producing the binder. It should also be stated that when some part of the plastic is said to be folded downward, it can be thought as being folded down into the plane of the table or away from the person producing the binder. Likewise, when the plastic is said to be folded upward, it is folded up from the plane of the table and toward the person producing the binder. The parts of L-shaped piece of plastic are cut edges (26), the vertical portion (2), the horizontal portion (3), the top of the vertical portion (4), the base of the vertical portion (5), the proximal region (6) of the horizontal portion, the distal region (7) of the horizontal portion, first bend line 8, the vertical edge (12) of the back cover, the bottom edge (13) of the back cover, bend line 14, bend line 15, the side edge (18) of the top cover, bend line 21, bend line 22, and the insert 25, beveled edges of the top cover (25a) and of the back cover (25b).

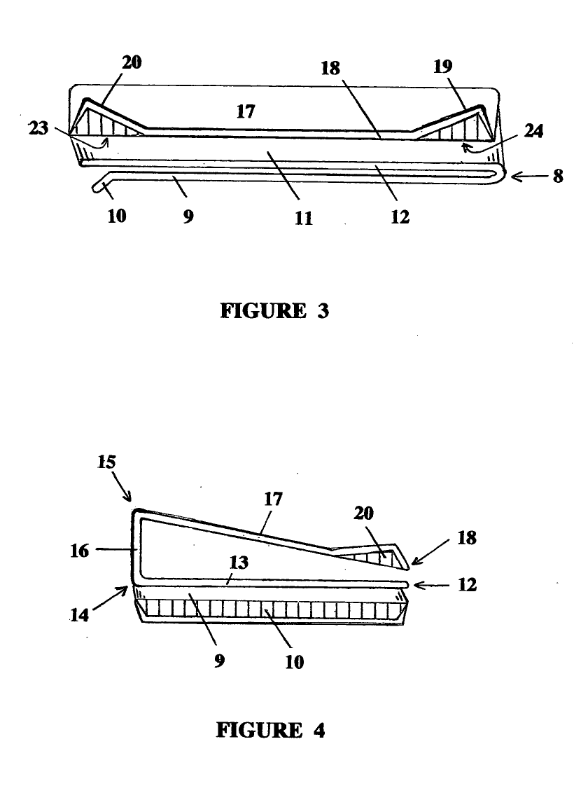

FIG. 3 shows a diagram of the right side of a right-handed binder in the preferred embodiment as described from top to bottom: the top cover (17), the bent top corner (19) of the top cover formed by heating and bending at bend line 24, the bent bottom corner (20) of the top cover formed by heating and bending at bend line 23, the side edge (18) of the top cover, the back cover (11), the clip (9) and the bent distal edge (10) of the clip. There is a 0.125 inch aperture defined by the fold at bend line 8 that forms the back cover and the clip as seen between the vertical edge (12) of the back cover and the clip (9).

FIG. 4 shows diagram of the base of a right-handed binder in the preferred embodiment as described from top to bottom: bend line 15, the top cover (17), the bottom corner (20) of the top cover, the spine (16), bend line 14, the horizontal edge (13) of the back cover, and the folded distal edge (10) of the clip (9). A clearance of 0.25 to 0.375 inches is shown on the right hand side of the diagram between side edge (18) of the top cover and the vertical edge (12) of the back cover.

The first step in the process for producing a binder is cutting a sheet (usually 4 feet by 8 feet) of plastic into L-shaped pieces. For the prototype binders, the plastic sheet was 0.125 inch LEXAN resin (GE Plastics, Seven Hills Ohio), a colorless transparent, thermoplastic, polycarbonate which was cut by hand using a Ridgid bandsaw (Emerson, St. Louis Mo.) or commercially (Jetstream Manufacturing, Springdale Ark.). For purposes of describing the process, each L-shaped piece of plastic has cut edges (26) that are represented by the outline of the L-shape, a vertical portion (2) measuring about 5 inches wide by about 16 inches high with a top (4) and a base (5); and a horizontal portion measuring about 5.75 inches to about 7.00 inches wide by about 8.25 inches high that is confluent with the base (12) of the vertical portion and has a proximal region (6) at the confluence and a distal region (7) distal to the proximal region as shown in FIG. 2.

To form the binder, the L-shaped piece of plastic is sequentially heated and bent (or folded) at various bend lines. A Black & Decker HG1000K Variable Temperature Heat Gun (Lowe's, Lowell Ark.) or a Free-Standing Heater FS-24 (Tap Plastics, Mountain View Calif.) is used to heat the plastic to 330C to 400C immediately before it is folded against a jig (or pattern) to form the desired angle. Bend line 8 located between the top (4) and base (5) of the vertical portion of the L-shaped piece of plastic shows where to heat and fold the top 7.75 inches of the vertical region downward towards the base. The top (4) of the vertical region was folded at about a 180 degree angle over a jig consisting of a flat piece of sheet metal with a thickness of about 0.125 inches to form a clip (9) and a back cover (11). The jig held the clip away from the back cover until the plastic cooled and hardened. When the jig was removed, the separation of the clip and back cover except at the fold at bend line 8 defines an aperture of about 0.125 inches. The clip (9) has a distal edge (10), and the back cover (11) has a vertical edge (12) and a horizontal edge (13).

Heating and folding the proximal region (6) of the horizontal portion at the bend line 14 folds about 5.75 inches to about 7.00 inches of the horizontal portion upward at about a 90 degree angle at the confluence between the horizontal (3) and the vertical (12) portions. A jig was used to form this 90 degree angle.

Heating and bending the horizontal portion a second time at bend line 15 about 1 inch to about 1.75 inches distal to bend line 14 folds about 5 inches to 5.25 inches of the distal region (7) of the horizontal portion at about a 110 degree angle to about a 130 degree angle downward over the back cover (11), thereby forming a spine (16) and a top cover (17) as shown in FIGS. 3 and 4. The top cover has a side edge (18) with a top corner (19) and a bottom corner (20) and is brought into approximate alignment with vertical edge (12) of the back cover; however, the top cover has about a 0.25-0.375 inch clearance above the vertical edge (12) of the back cover as shown in FIG. 4. The jigs used to fold bend line 15 were pieces of metal that presented an angle of about 110 degrees to be used with a spine (16) about 0.5 inches wide and about 130 degrees to be used with a spine about 1.25 inches wide. Differences in spine width permit insertion of a NACO approach chart from different regions of the United States; charts for regions containing major international airports (Chicago, Dallas, New York) are the thickest. The importance of the angle created at bend line 15 is to produce enough tension for the binder to hold and retain an approach plate securely.

The third step is polishing the cut edges (26) of the plastic shown in FIG. 2. All edges can be flame polished with a propane torch or flame polisher (Ryan Plastics, Northhamptonshire, England) or smoothed using a buffing wheel (Caswell Inc, Lyons N.Y.) mounted on power drill or motor.

The binder can be modified by additional steps—heating and bending at some additional bend lines and beveling some of the cut edges—to make the binder easier to use. One additional step comprises heating and folding at bend line 21, wherein 0.5 inch of the distal edge (10) of the clip is heated and folded downward at about a 30 degree angle to about a 45 degree angle as seen in FIGS. 2-4. To standardize this step, a jig was constructed with a slot that allows insertion of the distal edge (10) of the clip to a depth of about 0.5 inches and sets the angle of the bend. Bending the distal edge of the clip facilitates its attachment to another object such as a kneeboard or the loading of maps, flight plans and the like.

A second additional step comprises heating and bending at bend line 23, wherein 1 diagonal inch of the top corner (19) of the top cover is heated and bent upward at about a 30 degree angle to about a 45 degree angle. Alternatively, bend lines 23 and 24 are both heated and bent upward at about a 30 degree angle to about a 45 degree angle to form a top corner (19) and a bottom corner (20) as shown in FIG. 2. A jig can be constructed to allow insertion of the corners to a depth of 1 diagonal inch and to set the angle of the bend. For purposes of clarity, a diagonal inch is measured by marking the hypotenuse of two 0.75 inch lines centered on a corner of the top cover at a 90 degree angle.

An alternative step comprises heating and bending at bend line 22, wherein about 0.5 inches of the side edge (18) of the top cover is heated and bent upward at about a 30 to about a 45 degree angle. A jig can be constructed to allow insertion of the edge to a depth 0.5 inches and to set the angle of the bend. The alternative to making different jigs for the angles needed at each bend line is to use a sheet metal brake (McMaster Carr, Chicago Ill.) to bend the plastic to the various angles.

In a second alternative step, the side edge (18) of the top cover and the vertical edge (12) of the back cover can be beveled at about a 45 degree angle to a depth of approximately 0.25 inches as shown in FIG. 2. A hand router (Porter-Cable, Jackson Tenn.) can be used to bevel the sides of the top and back covers of the binder. All of the folds mentioned in the additional and alternative steps and beveling of the top cover will facilitate loading of an approach plate.

In the preferred embodiment, the binder has a top cover with top and bottom corners turned upward, a spine, a back cover, and a clip with the distal edge of the clip turned downward.

A left-handed binder can be produced to hold navigational aids more convenient for a left-handed user. To produce the left-handed binder, the L-shaped piece of plastic shown in FIG. 2 is flipped over so that the horizontal portion of the L points to the right. All steps are performed in the same manner and order described above with the result that navigational aids can be loaded into the left side of the left handed binder.

The binder can be produced from acrylic, polycarbonate, vinyl or hybrid resins (for example, polycarb-acrylic resins). In preferred embodiments, the plastic is a polycarbonate such as a Lexan resin (GE Plastics) or glycol-modified polyethylene terephthalate (PET-G) resin (SK Chemicals, Seoul Korea). The binder can be produced from any transparent or translucent plastic of any color through which the user can read a navigational aid. A color such as light yellow or light green can be selected to transmit light, increase contrast or ease eye strain. The plastic used to produce the binder can have a smooth surface that is easier to write on and erase, or it can have a matte finish to reduce glare.

The binder can be produced of a thermoplastic that is an optical grade magnifier. The magnification provided by optical grade polycarbonates or acrylics is useful in making small print or map detail more readable and is safer during dawn and dusk hours when light quality can compromise or reduce readability. In the alternative, it is contemplated that a sheet magnifier can be attached to the top of the binder to provide magnification.

A marker of any kind or a light source of any kind but preferably a light emitting diode or a fiberoptic light can be attached to the binder with a loop and hook fastener, with glue or a solvent compatible with the plastic being used, or any other means known in the art.

Usefulness

The formation of the binder from a single piece of plastic is particularly useful in that the clip, rather than a clamp, strap or belt, is used to attach the binder to a kneeboard; to a pocket of a pair of long pants; or to the pocket, hem or cuff of a pair of short pants, bicycle tights or similar attire. The binder securely holds and retains the flimsy pages of NACO and JEPP approach plates, navigation charts, road maps, and the like through the tension produced by angle of the third bend (bend line 15) that forms the top cover. The user can write directly upon the surface of the top cover of the binder, marking navigation coordinates or noting directions, license numbers, mileage or time logs, phone numbers, and the like.

Although the invention, as described, is particularly useful to pilots, it is contemplated that the binder can be used by any person, whether moving or stationary, needing a flat writing surface. It is contemplated that the invention can be used by firemen, police, rescue personnel and security officers, delivery or long distance truck drivers, persons carrying out factory or store inventory, reporters and students. Some of these persons will be seated and operating automobiles, emergency vehicles, helicopters, hot air balloons, bicycles, boats, trucks, and the like. Persons carrying out inventory can use the binder when moving through tightly spaced facilities such as aisles of stores and storage or warehousing facilities. Reporters or students can use the binder when attending a lecture or presentation in an auditorium with narrow seating or lacking any flat space or desk-like surface on which to rest a notebook.

Although the preferred embodiment of the present invention has been described for the purposes of illustration, it is to be understood that the invention is not limited to this embodiment and encompasses any and all embodiments within the scope of the usefulness of the invention and the following claims.

1. A process for producing a binder from a single piece of plastic comprising:
a) cutting a sheet of plastic into a L-shaped pieces, each L-shaped piece of plastic having cut edges, a vertical portion and a horizontal portion, wherein
i) the vertical portion measuring about 5 inches wide by about 16 inches high has a top and a base, and
ii) the horizontal portion measuring about 5.75 inches to about 7.00 inches wide by about 8.25 inches high is confluent with and extends to the left of the vertical portion, and has a proximal region near the confluence and a distal region away from the confluence;
b) heating the L-shaped piece of plastic;
c) bending the L-shaped piece of plastic at three bend lines, wherein
i) the vertical portion is bent at a first bend line to fold about 7.75 inches of the top of the vertical region at about a 180 degree angle down towards the base of the vertical region to form a clip with a distal edge and a back cover with a vertical edge and horizontal edge, thereby defining an aperture of about 0.125 inches between the clip and back cover,
ii) the horizontal portion is bent at a second bend line at the confluence with the vertical portion to fold about 5.75 inches to about 7.00 inches of the horizontal portion upward at about a 90 degree angle, and
iii) the distal region of the horizontal portion is bent at a third bend line about 1 inch to about 1.75 inches distal to the second bend line to fold about 5 inches to 5.25 inches of the distal region of the horizontal portion at about a 110 degree angle to about a 130 degree angle down and over the back cover to form a spine with a width of about 0.5 inches to about 1.25 inches and a top cover having a side edge with a top corner and a bottom corner, the top cover aligning with the back cover and leaving a clearance of at least 0.25 to about 0.375 inches between the side edge of the top cover and the vertical edge of the back cover; and
d) polishing the cut edges of the plastic, thereby producing the binder.

2. The process of claim 1 further comprising heating and bending about 0.5 inch of the distal edge of the clip downward at about a 30 degree angle to about a 45 degree angle.

3. The process of claim 1 further comprising heating and bending about 0.5 inches of the side edge of the top cover upward at about a 30 degree angle to about a 45 degree angle or 1 diagonal inch of the top corner of the top cover upward at about a 30 degree angle to about a 45 degree angle.

4. The process of claim 1 further comprising heating and bending about 1 diagonal inch of the top and bottom corners of the top cover upward at about a 30 degree angle to about a 45 degree angle.

5. The process of claim 1 further comprising beveling the side edge of the top cover and vertical edge of the back cover at about a 45 degree angle to a depth of approximately 0.25 inches.

6. A binder produced by the process of claim 1.

7. The binder of claim 1 wherein the plastic is transparent or translucent.

8. The binder of claim 1 wherein the plastic is selected from acrylic, polycarbonate, vinyl and hybrid resins.

9. The binder of claim 8 wherein the plastic is Lexan resin.

10. The binder of claim 8 wherein the plastic is glycol-modified polyethylene terephthalate resin.

11. The binder of claim 1 wherein the plastic is colored.

12. The binder of claim 1 wherein the plastic has a smooth or matte finish.

13. The binder of claim 1 wherein the plastic is an optical grade magnifier.

14. The binder of claim 6 wherein a sheet magnifier is attached to the top cover of the binder.

15. The binder of claim 6 wherein a marker is attached to the binder.

16. The binder of claim 6 wherein a light source is attached to binder.

17. The binder of claim 16 wherein the light source is a fiberoptic light or a light emitting diode.

18. The binder of claim 1 wherein the confluent horizontal portion of the L-shaped piece of plastic extends to the right at the beginning of the process.

19. A binder produced by the process of claim 18.
